(19) United States
(12) Patent Application Publication
(10) Pub. No.: US 2014/0014248 A1
(43) Pub. Date: Jan. 16, 2014

(54) PNEUMATIC TIRE AND METHOD FOR PRODUCING SAME

(71) Applicants: Alain Parfondry, Clermont-Ferrand (FR); Antonio Delfino, Clermont-Ferrand (FR); Ludovio Greverie, Ota-shi (JP); Damlen Fombelle, Clermont-Ferrand (FR)

(72) Inventors: Alain Parfondry, Clermont-Ferrand (FR); Antonio Delfino, Clermont-Ferrand (FR); Ludovio Greverie, Ota-shi (JP); Damlen Fombelle, Clermont-Ferrand (FR)

(73) Assignees: MICHELIN RECHERCHE ET TECHNIQUE S.A., GRANGES-PACCOT (CH); COMPAGNIE GENERALE DES ESTABLISSEMENTS MICHELIN, CLERMONT-FERRAND (FR)

(21) Appl. No.: 13/976,497

(22) PCT Filed: Dec. 28, 2010
(86) PCT No.: PCT/JP2010/073755

§ 371 Date: Oct. 1, 2013

(51) Int. Cl. B60C 5/00

(52) U.S. Cl. CPC B60C 19/002
USPC 152/450; 427/286

(57) ABSTRACT

A method for producing a pneumatic tire in which a noise damper in the form of at least one continuous ribbon for reducing cavity resonance in a tire cavity is provided on the internal surface of a tire on the inside in the radial direction of the tire corresponding to the tire tread, including, providing a vulcanized and shaped tire; mixing a composition for forming the noise damper with a foaming agent to produce a liquid composition; rotating the tire in an upright state by means of a tire holding and rotation device, and introducing the liquid composition onto the tire internal surface by a device for introducing the liquid composition; varying the relative positional relationship of the pneumatic tire and the introduction implement in the axial direction of the tire while introducing the liquid composition is introduced onto the tire internal surface, and forming the liquid composition into a gel; and foaming and drying the gelled liquid composition.

### BACKGROUND

1. Technical Field

The present invention relates to a pneumatic tire and to a method for producing same, and specifically the present invention relates to a pneumatic tire which is provided with a noise damper in the form of a continuous ribbon for suppressing cavity resonance generated in a tire cavity, and to a method for producing same.

2. Description of Related Art

Resonant vibration (cavity resonance) in a tire cavity is generated by the vibration of air enclosed in the tire cavity. The air in the tire cavity is generally excited by deformation of the tire tread part and sidewall part as the tire travels, and air enclosed in the annular cavity acts as an air column when this air is excited.

Sound waves which are excited in the tire cavity are transmitted inside the vehicle compartment as a solid-borne sound which spreads through the wheels, suspension and motor vehicle body, and is felt by vehicle passengers as disagreeable low-frequency noise.

Introducing a noise damper into the tire cavity is known as an effective means for reducing the cavity resonance, and Patent Document 1 describes technology involving a method for producing such a tire, in which a sponge material which is pre-molded into a strip shape is attached to the tire internal surface using double-sided adhesive tape whereby a tire of this type is produced.

Furthermore, Patent Document 2 describes technology involving a method for producing such a tire, in which the internal surface of a tire is coated with a liquid rubber composition which incorporates air bubbles, and the coated liquid rubber composition is foamed and cross-linked whereby a sponge material is formed.
Patent Document 1: JP2007-168243A
Patent Document 2: JP2008-213418A

### SUMMARY

However, with the technology described in Patent Document 1, the preparation steps require a large amount of time, such as preparing the sponge material which is pre-molded into a strip shape, cutting this material to the length to be attached, attaching the double-sided adhesive tape or the like to the attachment surface, and buffing the internal surface of the tire, etc., and there is a problem in that the tire production process as a whole can in no way be considered very labor efficient.

Furthermore, there is a problem with the technology described in Patent Document 1 and Patent Document 2 in that it is not possible to effectively produce a noise damper that can respond to the recent requirement of further reducing disagreeable low-frequency sound waves which are transmitted to vehicle passengers.

The present invention has therefore been devised in order to solve the abovementioned problems in the prior art, and the aim of the invention lies in providing a pneumatic tire which has better productivity and is provided with a noise damper in the tire cavity, and a method for producing same.

In order to achieve the abovementioned aim, the present invention provides a method for producing a pneumatic tire in which a noise damper in the form of at least one continuous ribbon for reducing cavity resonance in a tire cavity is provided on the internal surface of a tire on the inside in the radial direction of the tire corresponding to the tire tread, said method being characterized in that it includes the following stages: a stage in which a vulcanized and shaped tire which is not provided with the abovementioned noise damper is provided; a stage in which a composition for forming the noise damper is mixed with a foaming agent to produce a liquid composition; a stage in which the tire is rotated in an upright state by means of a tire holding and rotation device, and the liquid composition is introduced onto the tire internal surface by means of a device for introducing the liquid composition; a stage in which the relative positional relationship of the pneumatic tire and the introduction implement in the axial direction of the tire is varied while the liquid composition is introduced onto the tire internal surface, and the liquid composition introduced onto the tire internal surface is formed into a gel; and a stage in which the gelled liquid composition is foamed and dried.

The present invention having the constitution described above includes the following stages: a stage in which a composition for forming a noise damper is mixed with a foaming agent to produce a liquid composition; a stage in which the tire is rotated in an upright state by means of a tire holding and rotation device, and the liquid composition is introduced onto the tire internal surface by means of a device for introducing the liquid composition; a stage in which the relative positional relationship of the pneumatic tire and the introduction implement in the axial direction of the tire is varied while the liquid composition is introduced onto the tire internal surface, and the liquid composition introduced onto the tire internal surface is formed into a gel; and a stage in which the gelled liquid composition is foamed and dried, and therefore a noise damper in the form of at least one continuous ribbon extending at a predetermined angle with respect to the circumferential direction of the tire is formed on the tire internal surface. In addition to the sound-absorbing effect of the noise damper itself, a noise damper such as this impedes vibration of air which is excited in the tire cavity and propagates in the circumferential direction of the tire by virtue of the fact that the noise damper extends at a predetermined angle with respect to the circumferential direction of the tire, and therefore it is possible to effectively reduce cavity resonance. The tire is then rotated in an upright state by means of a tire holding and rotation device, the liquid composition is introduced onto the tire internal surface by means of the liquid composition introduction implement, the relative positional relationship of the pneumatic tire and the introduction implement in the axial direction of the tire is varied while the liquid composition is introduced onto the tire internal surface, and the liquid composition introduced onto the tire internal surface is formed into a gel then foamed and dried, and therefore it is possible to effectively provide a noise damper in the form of at least one continuous ribbon that extends at a predetermined angle with respect to the circumferential direction of the tire, and as a result it is possible to improve the productivity of a pneumatic tire which can further reduce cavity resonance.

According to the present invention, the speed of rotation of the tire and the time until the liquid composition forms a gel in the stage of introducing the liquid composition are preferably set in such a way that the liquid composition forms a gel before the tire has been rotated through 180°.

The invention having the constitution described above makes it possible to suppress events which may arise such as some of the ungelled liquid composition dropping downwards.

According to the present invention, the liquid composition is preferably a polyurethane composition.

The present invention having the constitution described above employs a polyurethane composition as the liquid composition, and therefore when said liquid composition forms a gel, a film portion is readily produced on the surface thereof, and this film portion prevents permeation of water into the noise damper, and as a result it is possible to achieve an effect whereby the durability of the noise damper in the form of a continuous ribbon is improved.

According to the present invention, the polyurethane composition preferably comprises at least MDI serving as an isocyanate, and polyether serving as a polyol.

According to the present invention, the foaming agent is preferably water.

According to the present invention having the constitution described above, the liquid composition can be foamed without the use of a costly foaming agent, and the gas which is produced is carbon dioxide, and therefore an operator is not subjected to any unpleasant odor and there is no adverse effect on the health of the operator.

According to the present invention, the speed of rotation of the tire when the liquid composition is introduced is preferably between 0.6 rpm and 300 rpm.

According to the present invention, the speed of rotation of the tire when the liquid composition is introduced is preferably between 12 rpm and 180 rpm.

According to the present invention, the time until the liquid composition forms a gel is preferably at least equal to 1 second but less than 60 seconds.

According to the present invention, the time until the liquid composition forms a gel is preferably at least equal to 3 seconds but less than 30 seconds.

According to the present invention, the liquid composition is preferably introduced without pretreatment of the internal surface of the vulcanized and shaped tire which is provided.

According to the present invention having the constitution described above, production steps can be omitted, such as when there is no need to clean the internal surface of the vulcanized and shaped tire, so it is possible to further improve the productivity of a pneumatic tire which can further reduce cavity resonance.

The pneumatic tire and method for producing same according to the present invention make it possible to improve productivity while reducing cavity resonance.

### BRIEF DESCRIPTION OF DRAWINGS

FIG. 1 schematically shows the cross section in the radial direction of a pneumatic tire provided with a noise damper, produced by means of the production method according to a mode of embodiment of the present invention.

FIG. 2 schematically shows the tire internal surface of a pneumatic tire provided with a noise damper, produced by means of the production method according to a mode of embodiment of the present invention.

FIG. 3 is a front view schematically showing one exemplary embodiment of a device for introducing the noise damper in the form of a continuous ribbon onto the tire internal surface, which is used in the production method according to a mode of embodiment of the present invention.

FIG. 4 is an enlargement of the main parts in FIG. 3 to illustrate the method of providing the continuous ribbon on the tire internal surface using the device shown in FIG. 3, where FIG. 4(a) is a front view showing the cross section of the tire viewed from the radial direction of the tire, and FIG. 4(b) is a side view showing the cross section of the tire viewed from the axial direction of the tire.

### DETAILED DESCRIPTION OF SPECIFIC EMBODIMENTS

A preferred mode of embodiment of the present invention will be described below with reference to the figures.

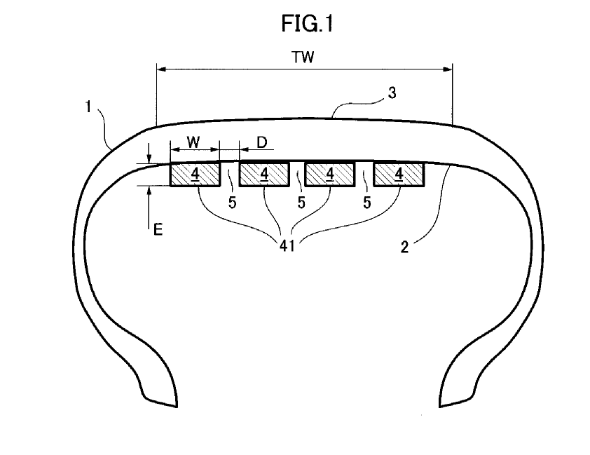

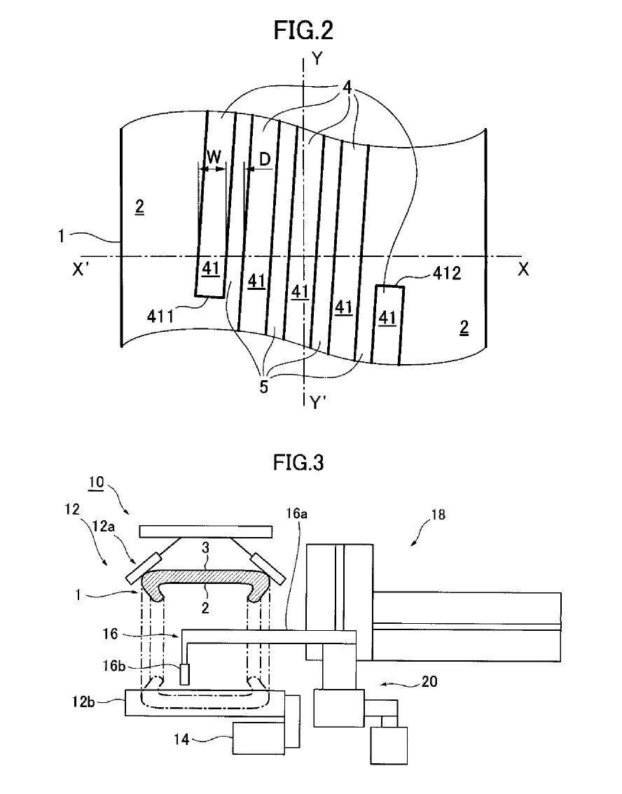

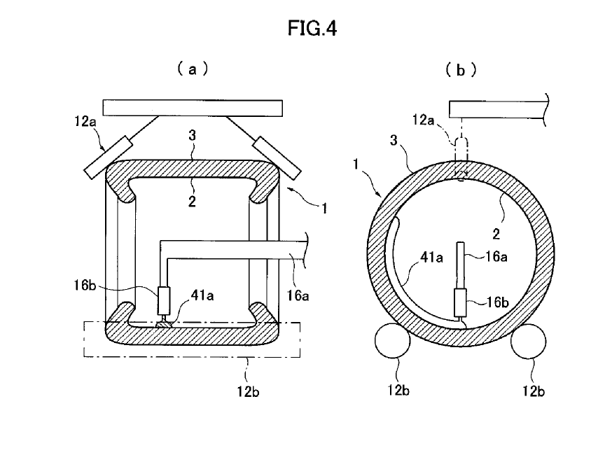

The pneumatic tire produced by means of the production method according to a mode of embodiment of the present invention will be described first of all with the aid of FIGS. 1 and 2. The method for producing a pneumatic tire according to a mode of embodiment of the present invention will be described later with the aid of FIGS. 3 and 4.

FIG. 1 schematically shows the cross section in the radial direction of a pneumatic tire provided with a noise damper, produced by means of the production method according to a mode of embodiment of the present invention, and FIG. 2 schematically shows the tire internal surface of a pneumatic tire provided with a noise damper, produced by means of the production method according to a mode of embodiment of the present invention. In FIG. 2 the circumferential direction of the tire is denoted by YY′, and the axial direction of the tire is denoted by XX′.

First of all, as shown in FIG. 1, the reference symbol 1 denotes a pneumatic tire 1 provided with a noise damper 4. The noise damper 4 serves to reduce cavity resonance, and it is formed by a continuous ribbon 41 having a width W and a thickness E, as shown in FIGS. 1 and 2, and is attached to an internal surface 2 of the pneumatic tire. Here, the “internal surface of the tire” (tire internal surface 2) refers to the surface of the tire facing the cavity, and in a normal state of usage of the tire (a state in which the tire is attached to a wheel) it is a surface which cannot be seen from the outside.

The continuous ribbon 41 is formed by a single continuous ribbon 41, which is continuously attached to the tire internal surface 2 running four times around said internal surface, in such a way as to be angled with respect to the circumferential direction of the tire. Continuous grooves 5 having a groove width D extending three times around the tire are formed on the internal surface 2 thereof by means of adjacent continuous ribbons 41 and the tire internal surface 2, as a result of a single continuous ribbon 41 being continuously attached four times around the tire internal surface. The continuous grooves 5 formed in this way also extend in such a way as to be angled with respect to the circumferential direction of the tire as shown in FIG. 2. That is to say, in this mode of embodiment, the continuous ribbon 41 is attached in such a way as to extend at a predetermined angle with respect to the circumferential direction of the tire, and the continuous grooves 5 are formed by adjacent continuous ribbons 41 and the tire internal surface 2.

As shown in FIG. 1, the tire 1 has a tread surface 3 having a width TW which comes into contact with the road surface during travel. It should be noted that the tire size in this example is 225/55R16.

The width W of the continuous ribbon 41 is formed in such a way as to be between 5% and 25% of the width TW of the tread 3. In this mode of embodiment the width TW of the tread 3 is 168 mm and the width W of the continuous ribbon 41 is 24 mm.

The thickness E of the continuous ribbon 41 is formed in such a way as to be between 50% and 200% of the width W of the continuous ribbon 41. In this mode of embodiment the thickness E of the continuous ribbon 41 is 15 mm.

The continuous ribbon 41 is made of a sound-absorbing material which has excellent anti-vibration properties and sound absorption properties. The continuous ribbon 41 is preferably a single continuous ribbon, but it is equally possible to form a single continuous ribbon by combining multiple short ribbons. The sound-absorbing material which forms the continuous ribbon 41 is preferably any one material selected from the group consisting of sponge, a foamed rubber composition, glass wool, rock wool, and cellulose fibre. The continuous ribbon 41 in this mode of embodiment is formed as a sponge material by means of a method which will be described later.

The continuous ribbon 41 may be formed while directly introducing (injecting), for example, a polyurethane-based material for forming the sponge material into the tire cavity, as will be described later. In this way, if, for example, the polyurethane-based material is directly introduced into the tire cavity, there may be a difference in the growth rate of the material at the material surface and inside the material due to differences in the material temperature and environmental temperature during the process of forming the continuous ribbon 41, and a thin film-like portion may be formed at the material surface. The film-like portion which is present at the surface of this continuous ribbon 41 may produce an effect of preventing water from penetrating into the continuous ribbon 41 and improving the durability of the continuous ribbon 41.

The continuous ribbon 41 is fixed to the tire internal surface 2 in such a way as to occupy a range of at least 30% of the range of the tire internal surface 2 corresponding to the range where the tread 3 is formed on the inside in the radial direction of the tread 3. In this mode of embodiment, the continuous ribbon 41 is fixed to the tire internal surface 2 in such a way as to occupy a range of 85% on the inside in the radial direction of the tread 3, in other words the continuous ribbon 41 is fixed to the tire internal surface 2 in such a way as to cover 85% of the range of the tire internal surface 2 corresponding to the tread 3.

The width D of the continuous groove 5 is formed in such a way as to be at least equal to 20% of the width W of the continuous ribbon 41. In this mode of embodiment, the width D of the continuous groove 5 is 13 mm.

The continuous ribbon 41 shown in the cross-sectional view in the radial direction in FIG. 1 is formed only by a single continuous ribbon 41, as described above; as shown in FIG. 2, this continuous ribbon 41 comprises two ends, namely a start end 411 and a terminal end 412, and these two ends are formed in such a way as to be offset from each other in the axial direction, in other words in such a way as to have a space therebetween. The amount of offset of the two ends 411, 412 in this mode of embodiment is 148 mm.

In this way, with the pneumatic tire 1 according to this mode of embodiment, the continuous ribbon 41 attached to the tire internal surface 2 comprises two ends, namely the start end 411 and the terminal end 412, as shown in FIG. 2, and these two ends 411, 412 are formed in such a way as to be offset from each other in the axial direction. The continuous ribbon 41 is provided on the tire internal surface 2 in such a way that a single continuous ribbon 41 runs four times around the tire, as described above, in other words it runs four times at a predetermined angle with respect to the circumferential direction of the tire, and as a result the continuous grooves 5 are formed running three times around the tire by adjacent continuous ribbons 41 and the tire internal surface 2.

It should be noted that with the pneumatic tire 1 according to this mode of embodiment, the start end 411 and terminal end 412 are provided at positions which are offset on the axis of the tire internal surface 2 as a result of the continuous ribbon 41 running four times around the circumferential direction of the tire, as shown in FIG. 2, but if the continuous ribbon 41 runs three times around the circumferential direction of the tire, for example, the continuous ribbon 41 may be provided in such a way that the start end 411 and terminal end 412 are provided at positions which are offset with respect to the circumferential direction of the tire and the start end 411 and terminal end 412 are offset in the axial direction at different positions on the axis of the tire internal surface 2.

It should be noted that in the example of the tire according to this mode of embodiment, the cross-sectional shape of the continuous ribbon 41 is rectangular, but this cross-sectional shape is not limited to a rectangular shape. The cross-sectional shape of the continuous ribbon 41 should be a cross-sectional shape which enables the continuous grooves 5 to be formed, and said shape may be appropriately modified to a semicircular or trapezoidal shape, or a shape in which the side surfaces or upper surface are expanded in the form of a curve, among others. It should be noted that when the continuous ribbon 41 has a cross-sectional shape other than a rectangular shape, the width W of the continuous ribbon 41 is the maximum width projected onto the tire internal surface 2, and the thickness E is the maximum thickness in the radial direction of the tire.

Furthermore, the continuous ribbon may be formed in such a way as to meander at a predetermined angle with respect to the circumferential direction of the tire in such a way as to form the continuous grooves. In this case, the width D of the continuous grooves may vary continuously in the direction of extension of the continuous ribbon, or the meandering shape of adjacent continuous ribbons may be arranged in such a way that the width D of the continuous grooves is constant.

The main action and effects of the pneumatic tire provided with a noise damper according to this mode of embodiment will be described next.

The continuous ribbon 41 is first of all formed in such a way as to be angled with respect to the circumferential direction of the tire in order to prevent propagation of sound waves from cavity resonance which progress in the circumferential direction of the tire, and therefore cavity resonance can be effectively reduced.

Here, cavity resonance is generated because air enclosed in the annular cavity acts as an air column as the tire travels, and this cavity resonance is a cause of air vibration whereby the inside of the air column mainly spreads in the circumferential direction of the tire. The continuous ribbon 41 is therefore disposed in such a way as to extend obliquely at a predetermined angle with respect to the circumferential direction of the tire, whereby it is possible to effectively reduce cavity resonance.

Furthermore, as described above, the continuous grooves are formed in such a way as to extend at a predetermined angle with respect to the circumferential direction of the tire, and therefore the energy of air vibration which propagates mainly in the circumferential direction of the tire from cavity resonance conducted into the continuous grooves 5 is divided into a component which permeates into the continuous ribbon 41, and a component which is reflected by the surface of the continuous ribbon 41. The energy component which permeates into the continuous ribbon 41 is attenuated by the effect of the sound-absorbing material which forms the continuous ribbon 41, and the component which is reflected by the surface of the continuous ribbon 41 is not only attenuated by reflection thereof, the energy thereof also reaches other sections of the continuous ribbon 41 whereby the abovementioned permeation/reflection phenomena are repeated, so cavity resonance can be more effectively reduced.

In addition, according to this mode of embodiment, the groove width D of the continuous groove 5 is at least equal to 20% of the width W of the continuous ribbon, so the area over which the tire internal surface comes into direct contact with air in the tire cavity by way of the continuous groove can be made a sufficient area to radiate heat. This means that the heat mainly generated in the tread while the tire is travelling can be reliably released from the tire internal surface to the tire cavity even though the continuous ribbon 41 constituting the noise damper 4 is provided running multiple times (four times in this mode of embodiment) around the inside of the tread 3 in the radial direction thereof, and as a result it is possible to maintain high-speed durability.

In addition, the structure in this mode of embodiment is such that a single continuous ribbon 41 is fixed in the tire cavity running four times around the tire in such a way as to extend obliquely with respect to the circumferential direction of the tire, and therefore a fixing method may be adopted in which, for example, the start end 411 of the continuous ribbon 41 is fixed to the tire internal surface, after which the continuous ribbon 41 should continue to be fixed up to the terminal end 412 thereof while the tire 1 is rotated about the axis of rotation thereof and the continuous ribbon 41 or the tire 1 itself is moved in the axial direction. In this way, the tire 1 provided with the noise damper 4 according to this mode of embodiment enables the continuous ribbon 41 to be attached with relative ease, and the productivity of the tire 1 provided with the continuous ribbon 41 constituting the noise damper 4 can be maintained.

In addition, according to this mode of embodiment, the width W of the continuous ribbon 41 is formed in such a way as to be between 5% and 25% of the width TW of the tread 3. Here, if the width W of the continuous ribbon is less than 5% of the width TW of the tread 3, the width W of the continuous ribbon 41 is excessively small, and it is necessary to increase the number of turns of the continuous ribbon in order to effectively reduce cavity resonance, and productivity is reduced. On the other hand, if the width W of the continuous ribbon 41 is more than 25% of the tread width TW, the proportion of the tire internal surface 2 occupied by the continuous ribbon increases, and as a result the proportion of the tire internal surface 2 which comes into contact with air in the tire cavity is reduced, so the high-speed durability is reduced. Accordingly, if the width W of the continuous ribbon 41 is set between 5% and 25% of the tread width TW, it is possible to ensure high-speed durability and to maintain productivity while a reduction in cavity resonance can be envisaged.

In addition, according to this mode of embodiment, the thickness E of the continuous ribbon 41 is formed in such a way as to be between 50% and 200% of the width W of the continuous ribbon 41. Here, if the thickness E of the continuous ribbon 41 is less than 50% of the width W of the continuous ribbon 41, the thickness E of the continuous ribbon 41 does not have a sufficient height to impede propagation of sound waves from air vibration in the tire cavity, so the degree of reduction in cavity resonance is reduced. On the other hand, if the thickness E of the continuous ribbon 41 is greater than 200% of the width W of the continuous ribbon 41, the sound-suppression effect afforded by the continuous ribbon 41 plateaus, and therefore this adversely affects the cost and weight of the tire. Accordingly, if the thickness E of the continuous ribbon 41 is set between 50% and 200% of the width W of the continuous ribbon 41 it is possible to reduce cavity resonance more effectively, and it is possible to suppress increases in the cost and weight.

Using FIGS. 3 and 4, a description will be given next of the method for producing a pneumatic tire in accordance with a mode of embodiment of the present invention, in order to produce a pneumatic tire provided with the continuous ribbon 41 which is shown in FIGS. 1 and 2 described above, and also the production device for providing the continuous ribbon on the tire internal surface 2. FIG. 3 schematically shows one exemplary embodiment of a device for introducing the noise damper in the form of a continuous ribbon onto the tire internal surface, FIG. 3 being shown as a front view seen from the radial direction of a tire held in the device. FIG. 4 is an enlargement of the main parts of FIG. 3 for illustrating the method for providing the continuous ribbon 41 on the tire internal surface using the device shown in FIG. 3, FIG. 4(a) being a front view seen from the radial direction of the tire, and FIG. 4(b) being a side view seen from the axial direction of a tire held in the device. The cross section of the tire is shown in FIGS. 4(a) and 4(b).

As shown in FIG. 3, a device 10 for introducing the noise damper in the form of a continuous ribbon onto the tire internal surface according to this exemplary embodiment is provided with a tire holding and rotation device 12 which can hold and rotate in an upright state a tire which has been produced in advance by vulcanization and shaping. The tire holding and rotation device 12 comprises an upper rotation and holding device 12a which holds the tire 1 in an upright state and also allows rotation of the tire 1, and a lower rotation and holding device 12b which holds the tire 1 in an upright state and also causes rotation of the tire 1. Furthermore, the device 10 comprises a tire drive device 14 for driving the lower holding and rotation device 12b and rotating the tire 1 in an upright state.

In addition, the device 10 is provided with: an introduction implement (nozzle) 16 for introducing/injecting a liquid composition for forming the noise damper in the form of a continuous ribbon onto the tire internal surface 2 which is held in an upright state by means of the tire holding and rotation device 12; an introduction implement holding/moving device 18 which is constructed in such a way as to be able to move the position of the introduction implement 16 in the height direction (radial direction) and the axial direction of the tire 1 which is positioned and held on the tire holding and rotation device 12; and a mixing device 20 for mixing a composition in liquid form for forming the noise damper with a foaming agent in order to produce the liquid composition; the liquid composition in the mixing device 20 is conducted to a nozzle 16b provided at the tip end of the introduction implement 16 by way of a passage 16a in the introduction implement 16.

Rotation of the tire 1 produced by the tire drive device 14 is transmitted to the lower holding and rotation device 12b either by way of a chain or gear etc., or through direct contact. Furthermore, operation of a drive mechanism which is provided in addition to movement of the introduction implement holding/moving device 18 is also transmitted to the introduction implement holding/moving device 18 either by way of a chain or gear etc., or through direct contact, and the introduction implement 16 moves to a predetermined position.

As shown in FIG. 4, the pneumatic tire 1 which has been vulcanized and shaped is first of all held in an upright state by means of the tire holding and rotation device 12. At this point, the liquid composition in which the composition in liquid form for forming the noise damper and the foaming agent have been mixed inside the mixing device 20, are introduced into the introduction implement 16.

The pneumatic tire which is held in an upright state by means of the tire holding and rotation device 12 then first of all starts to undergo rotation by means of the tire drive device 14 and the tire holding and rotation device 12, after which the introduction implement 16 is moved in the axial direction of the tire by means of the introduction implement holding/moving device 18 and advances into the tire cavity, moving as far as a predetermined position as shown in FIG. 4, after which the liquid composition 41a starts to be introduced from the nozzle 16b of the introduction implement 16 onto the tire internal surface 2.

It should be noted that the start of rotation of the tire produced by the tire drive device 14 and tire holding and rotation device 12 may come after the introduction implement 16 has been moved into the tire cavity, or rotation of the tire 1 may be started before the start of introduction of the liquid composition onto the tire internal surface 2. Furthermore, the position in the direction of rotation of the tire of the nozzle 16b of the introduction implement 16 with respect to the centre of rotation of the tire is preferably a position on an imaginary axis including the center of rotation of the tire, in other words a position which allows introduction/injection of the liquid composition onto the tire internal surface 2 at the very lowest position in the height direction of the tire. Furthermore, depending on the size of the tire into which the noise damper in the form of a continuous ribbon is being introduced, appropriate operations may also be performed such as moving the introduction implement holding/moving device 18 in the height direction of the tire and also in the axial direction of the tire, and making the introduction implement 16 advance into the tire cavity in such a way that there is no interference between the tire 1 and the introduction implement 16.

As shown in FIG. 4(b), after introduction of the liquid composition 41a onto the tire internal surface 2 has started, the tire 1 continues to be rotated by means of the tire drive device 14, while at the same time the introduction implement 16 is moved continuously in the axial direction of the tire by means of the introduction implement holding/moving device 18, whereby the relative positional relationship of the internal surface 2 of the tire 1 and the introduction implement 16 is varied in the axial direction of the tire and the liquid composition 41a continues to be introduced/injected without interruption until the tire has made a predetermined number of rotations or the tire has reached a predetermined position in the axial direction thereof; as a result, the noise damper 4 comprising the continuous ribbon 41 can be placed at a predetermined angle with respect to the direction of rotation of the tire, as shown in FIGS. 1 and 2 described above.

It should be noted that with the device 10 according to this exemplary embodiment, the introduction implement 16 is moved in the axial direction relative to the tire 1 which is held in a fixed axial position by means of the tire holding and rotation device 12, and the noise damper 41 (4) in the form of a continuous ribbon is formed on the internal surface 2 of the tire, but it is equally possible for the noise damper 41 (4) in the form of a continuous ribbon to be formed on the internal surface 2 of the tire by means of a device with which the position of the introduction implement 16 in the axial direction of the tire is fixed, and the tire holding and rotation device 12 or tire drive device 14 is provided with a means for moving the tire in the axial direction, so that the relative positional relationship of the tire 1 and introduction implement 16 can be varied.

According to this mode of embodiment, a liquid composition (to be described more specifically below) which starts to undergo gelification after a predetermined amount of time has elapsed, after having been injected onto the tire internal surface 2 by means of the nozzle 16b, is used as the liquid composition 41a which is introduced onto the tire internal surface 2 in order to form the continuous ribbon 41. The number of turns of the tire and the time until the liquid composition forms a gel are set in such a way that gelification is completed before the tire has rotated through 180°. By virtue of these settings, it is possible to suppress events which may arise such as some of the ungelled liquid composition 41a dropping downwards.

After this, the liquid composition 41a starts to foam due to a reaction with the foaming agent mixed with the liquid composition 41a, and the mixture is cooled/dried by the ambient temperature, and foaming is completed, whereby the liquid composition 41a introduced onto the tire internal surface changes into a sound-absorbing material, and as a result the liquid composition 41a is fixed to the tire internal surface 2 as the continuous ribbon 41, thereby forming the noise damper 4 for reducing cavity resonance (see FIGS. 1 and 2).

As described above, the number of turns of the tire 1 is set in such a way that the liquid composition 41a has gelled before the tire has rotated through 180°. According to this mode of embodiment, the number of turns of the tire 1 is set at between 0.6 rpm and 300 rpm, but this number is preferably set at between 12 rpm and 180 rpm.

Furthermore, according to this mode of embodiment, the liquid composition 41a which is used is a liquid composition 41a for which the time until gelification is from 1 second to less than 60 seconds, and a liquid composition 41a which gels in a time from 3 seconds to less than 30 seconds is preferably used.

The number of turns of the tire 1 is appropriately set according to the liquid composition 41a which is used.

It should be noted that there may be a difference in the growth rate (foaming rate) of the material at the material surface and inside the material due to differences in the material temperature of the liquid composition 41a and the ambient temperature during the process of forming the noise damper, and a thin film-like portion may be formed at the material surface. The film-like portion which is present at the surface of this noise damper in the form of a continuous ribbon makes it possible to achieve an effect of preventing water from penetrating into the noise damper in the form of a continuous ribbon and improving the durability of the noise damper in the form of a continuous ribbon. A liquid composition 41a which readily allows this kind of film portion to be formed is, for example, a polyurethane composition.

The liquid composition 41a is a mixture of the foaming agent and a composition in liquid form for forming the noise damper, and the mixing device 20 for introducing said composition into the introduction implement 16 should be able to mix a predetermined composition with a predetermined foaming agent, and introduce this mixture into the introduction implement 16. In the device 10 according to this exemplary embodiment, a high-shear dynamic mixer and a gear pump are used as the mixing device 20, and but it is sufficient to be able to satisfy the functions of this mixing device, in other words it should be possible to mix the predetermined composition with the predetermined foaming agent. The form of this mixing device may be appropriately varied, and examples include a form in which a high-shear dynamic mixer is combined with a rotary piston pump, a form in which a low-shear mixer is combined with any kind of pump, or a form in which an impact mixer is combined with any kind of pump.

A polyurethane composition or rubber composition or the like may be used as the composition in liquid form for forming the noise damper 4, which serves as the sound-absorbing material, but a polyurethane composition is preferred. The prepolymer which is compounded with the polyurethane composition generally has low viscosity and enables good moistening of the surface of a base material (the tire internal surface 2 in this case) and also contains sufficient NCO to enable the formation of covalent bonds at the surface of the base material (the tire internal surface 2), and therefore is also utilized as an adhesive for self-adhesion, so the noise damper in the form of a continuous ribbon can be fixed to the tire internal surface without the introduction of a separate adhesive. Depending on the state of the internal surface of the pneumatic tire into which the noise damper in the form of a continuous ribbon is introduced, the tire internal surface may be subjected to a suitable treatment such as cleaning using a primer as a pretreatment before the noise damper is provided. On the other hand, if there is no need to clean the internal surface of the tire which has been vulcanized and shaped, the liquid composition 41a is injected/introduced onto the tire internal surface 2 directly after the tire 1 itself has been vulcanized and shaped, without a pretreatment being carried out.

The foaming agent which is used in this exemplary embodiment is water. The isocyanate which is compounded with the polyurethane composition produces carbon dioxide as a result of the chemical reaction with water, so it is possible to foam the liquid composition without the use of a costly foaming agent. Furthermore the gas which is produced is carbon dioxide, so an operator is not subjected to any unpleasant odor and there is no adverse effect on the health of the operator.

The isocyanate which is used in this exemplary embodiment is MDI. It is equally possible to use TDI as the isocyanate, but MDI has higher viscosity during shaping than TDI, so this is preferred in the case of a production method in which a liquid composition is introduced into a rotating tire, as in the present case.

The polyol which is used in this exemplary embodiment is a polyether. It is equally possible to use other raw materials as the polyol, but when a polyether-based polyol is used, the elasticity is superior to when a polyester-based polyol in particular is used, a polyether-based polyol is less hydrolysable, and a noise damper in the form of a continuous ribbon can be obtained at lower cost.

A particularly preferred mode of embodiment of the present invention has been described above, but the present invention is not limited to the mode of embodiment shown in the figures and a number of various modes may be implemented.

### KEY TO SYMBOLS

1 Pneumatic tire
2 Tire internal surface
3 Tread
4 Noise damper
41 Continuous ribbon formed by means of noise damper
411 Start end of continuous ribbon
412 Terminal end of continuous ribbon
5 Continuous groove
41a Liquid composition
10 Device for introducing noise damper in the form of a continuous ribbon onto the tire internal surface
12 Tire holding and rotation device
14 Tire drive device
16 Introduction implement (nozzle) for introducing/injecting liquid composition onto the tire internal surface
18 Introduction implement holding/moving device for moving the position of the introduction implement 16
20 Mixing device

1. A method for producing a pneumatic tire in which a noise damper in the form of at least one continuous ribbon for reducing cavity resonance in a tire cavity is provided on the internal surface of a tire on the inside in the radial direction of the tire corresponding to the tire tread, comprising:
providing a vulcanized and shaped tire which is not provided with the abovementioned noise damper;
mixing a composition for forming the noise damper with a foaming agent to produce a liquid composition;
rotating the tire in an upright state by means of a tire holding and rotation device, and introducing the liquid composition onto the tire internal surface by means of a device for introducing the liquid composition;
varying the relative positional relationship of the pneumatic tire and the introduction device in the axial direction of the tire while the liquid composition is introduced onto the tire internal surface, and forming the liquid composition introduced onto the tire internal surface into a gel; and
foaming and drying the gelled liquid composition.

2. A method for producing a pneumatic tire according to claim 1, wherein the speed of rotation of the tire and the time until the liquid composition forms a gel in the introducing the liquid composition are set in such a way that the liquid composition forms a gel before the tire has been rotated through 180°.

3. The method for producing a pneumatic tire according to claim 2, wherein the liquid composition is a polyurethane composition.

4. The method for producing a pneumatic tire according to claim 3, wherein the polyurethane composition comprises at least MDI serving as an isocyanate, and polyether serving as a polyol.

5. The method for producing a pneumatic tire according to claim 4, wherein the foaming agent is water.

6. The method for producing a pneumatic tire according to claim 5, wherein the speed of rotation of the tire when the liquid composition is introduced is between 0.6 rpm and 300 rpm.

7. The method for producing a pneumatic tire according to claim 6, wherein the speed of rotation of the tire when the liquid composition is introduced is between 12 rpm and 180 rpm.

8. The method for producing a pneumatic tire according to claim 7, wherein the time until the liquid composition forms a gel is at least equal to 1 second but less than 60 seconds.

9. The method for producing a pneumatic tire according to claim 8, wherein the time until the liquid composition forms a gel is at least equal to 3 seconds but less than 30 seconds.

10. The method for producing a pneumatic tire according to claim 9, wherein the liquid composition is introduced without pretreatment of the internal surface of the vulcanized and shaped tire which is provided.

11. Pneumatic tire produced by the method according to claim 10.
